(19) United States
(12) Patent Application Publication
(10) Pub. No.: US 2007/0110894 A1
(43) Pub. Date: May 17, 2007

(54) Method for drying coating film, and optical film

(75) Inventors: Makoto Komatsubara, Osaka (JP); Ryuuichi Inoue, Hiroshima (JP); Mie Oota, Hiroshima (JP); Kazuki Tsuchimoto, Hiroshima (JP); Seiji Kondou, Hiroshima (JP); Tomoaki Masuda, Hiroshima (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibarki-shi, Osaka (JP)

(21) Appl. No.: 10/548,409

(22) PCT Filed: Mar. 4, 2004
(86) PCT No.: PCT/JP04/02720

§ 371 Date: Sep. 8, 2005

(30) Foreign Application Priority Data
Mar. 7, 2003 (JP) 2003-061805

(51) Int. Cl. B05D 3/02; B05D 5/06

(52) U.S. Cl. 427/162; 427/372.2; 427/163.1

(57) ABSTRACT

The present invention relates to a method of drying a coating film, and its object is to produce a coating film with small variations in thickness with stability. Thus, in the method of drying a coating film 11 formed by application of a coating solution to a long-length substrate 10 which is traveling, the coating film 11 is dried immediately after the application of a coating solution to the long-length substrate 10, with an evaporation rate of a solvent kept at 0.1 g/m² s or less. Preferably, on a travel path of the coating film 11 immediately after coating, a plate 20 should be provided with a predetermined air gap between itself and the coating film 11 thereby to control the evaporation rate of the coating solution.

### TECHNICAL FIELD

The present invention relates to a technique for continuously drying a coating solution applied to a long length of traveling substrate, and especially relates to a method for the drying, an optical film having a laminated structure of optically functional layers formed by that method, a polarizing plate with that optical film, and an image display system comprising that polarizing plate.

### BACKGROUND ART

One of the methods for continuously drying a coating film formed by application of a coating solution to a long length of traveling substrate is to blow an air-conditioned wind to a coated surface from one direction (described in, for example, Japanese Patent Application Laid-open No. 2001-170547). Other drying methods include, for example, blowing hot air to a coated surface or applying far infrared rays in a drying system after coating.

Now, in recent years, in the field of films or the like for optical use such as a liquid crystal display, the requirement for appearances after coating has become strict depending on the usage. Especially, thin-layer coated products of 10 μm or smaller often show very noticeable unevenness in appearance caused by unevenness of a coating film, but they are required to reduce such unevenness in appearance.

However in conventional drying methods, during the time between when a coating solution is applied to a long length of traveling substrate in a coating system and when the coating solution is dried in a drying system, there is a zone where the substrate is exposed to ambient environment around the systems, which causes, for example, variations in the drying rate by the influence of disturbance factors such as an irregular speed and/or direction of wind from the ambient environment. This causes differences in the surface tension of the coating film and a flow of the coating solution, thereby causing a problem of variations in coating film thickness and resultant unevenness in appearance.

### DISCLOSURE OF INVENTION

The present invention has been made in view of the above problems, and its object is to provide a method of drying a coating film, which enables the stable provision of a coating film with little variations in thickness, and to provide an optical film having a laminated structure of optically functional layers formed by that method, a polarizing plate with that optical film, and an image display system comprising that polarizing plate.

The inventors of the present invention have found out that, in drying a coating film formed by application of a coating solution to a long length of traveling substrate, the coating film can be dried uniformly and formed to a uniform thickness by setting the evaporation rate (drying rate) of the coating solution immediately after coating at 0.1 g/m²·s or less.

Thus, in the method of drying a coating film formed by application of a coating solution to a long length of traveling substrate according to the present invention, immediately after the application of the coating solution to the long-length substrate, drying is done with the evaporation rate of a solvent kept at 0.1 g/m²·s or less. Thereby, the coating film can be dried uniformly and produced to have little variations in thickness with stability. Thus, a good appearance is produced after formation of the coating film.

Also, drying with the evaporation rate of 0.1 g/m²·s or less should preferably be done until a long-length substrate coated with a coating solution enters a drying system. However, drying may be completed only with the drying process using the evaporation rate of 0.1 g/m²·s or less without providing other drying systems.

Further, in the present invention, it is desirable, in order to keep the evaporation rate at 0.1 g/m²·s or less, that a plate parallel to a long-length substrate immediately after being coated with a coating solution be provided with an air gap between the plate and the coating film. This prevents the entrance of wind or the like from the ambient environment into the air gap between the plate and the coating film and allows the air gap to be filled almost with vapors of a solvent, thereby keeping the evaporation rate at 0.1 g/m²·s or less.

Further, the temperature of the above plate should preferably be controlled to be not less than the dew point of vapors of the coating solution. This allows the evaporation rate to be controlled in the range of not more than 0.1 g/m²·s and prevents condensation of vapors, thereby enabling stable drying.

It is also desirable to provide fins on the surface of the above plate on the side facing the long-length substrate. This prevents airflow caused by travel of the long-length substrate from affecting the coating film which has not yet been dried, thereby enabling the production of the coating film with a uniform thickness.

Further, more stable drying is possible with the viscosity of the coating solution of not more than 300 mPa·s. More preferably, the viscosity of 50 mPa·s or less enables especially stable drying.

Further, the coating film should preferably be an optically functional layer having optical functions. By so doing, even in the case of producing a coated product for optical use which have stringent requirements for appearance in recent years, the coated product can have little unevenness in appearance.

By using the aforementioned drying method for production of an optical film with a laminated structure of optically functional layers, it is possible to obtain an film which has little unevenness in appearance and is thus suitable for optical use. Further by laminating such an optical film to a polarizing plate, it is possible to obtain a polarizing plate which has little unevenness in appearance and is thus suitable for optical use.

Further, an image display system produced using such a polarizing plate can have little unevenness in appearance and can improve its quality.

The present invention is also directed to a method of drying a coating film formed by application of a coating solution to a long length of traveling substrate, in which a plate with a plate width of not less than the width of the long-length substrate is provided on the downstream of a coating system of a coating solution along a travel path of the long-length substrate, and the long-length substrate immediately after a coating film is formed thereon by the coating system travels along the travel path with the coating film facing the plate surface of the plate with a predetermined gap, whereby at least part of the coating film is dried when passing through the gap. This allows drying while reducing the influence of wind or the like from the ambient environment, thereby enabling stable production of a coating film with little variations in thickness.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a diagram showing a structure in which a plate is provided on the side of a long-length substrate where a coating film is formed;

FIG. 2 is a diagram showing a structure in which plates are provided on both sides of a long-length substrate where a coating film is formed and where a coating film is not formed;

FIG. 3 is a diagram showing a structure in which a surrounding plate is provided to surround a long-length substrate immediately after being coated with a coating solution;

FIG. 4 is a diagram showing a structure in which flat-plate fins are provided on the plate in the structure of FIG. 1;

FIG. 5 is a diagram showing the mean values of the coating film thickness in Example 1 and Comparative Example 1;

FIG. 6 is a diagram showing the variance of the coating film thickness in Example 1 and Comparative Example 1;

FIG. 7 is a diagram showing the mean values of the coating film thickness in Example 2 and Comparative Example 2; and

FIG. 8 is a diagram showing the variance of the coating film thickness in Example 2 and Comparative Example 2.

### BEST MODE FOR CARRYING OUT THE INVENTION

Hereinbelow, a preferred mode of the present invention that is applicable to a manufacturing process of a polarizing plate or the like in an image display system will be described in detail with reference to the drawings.

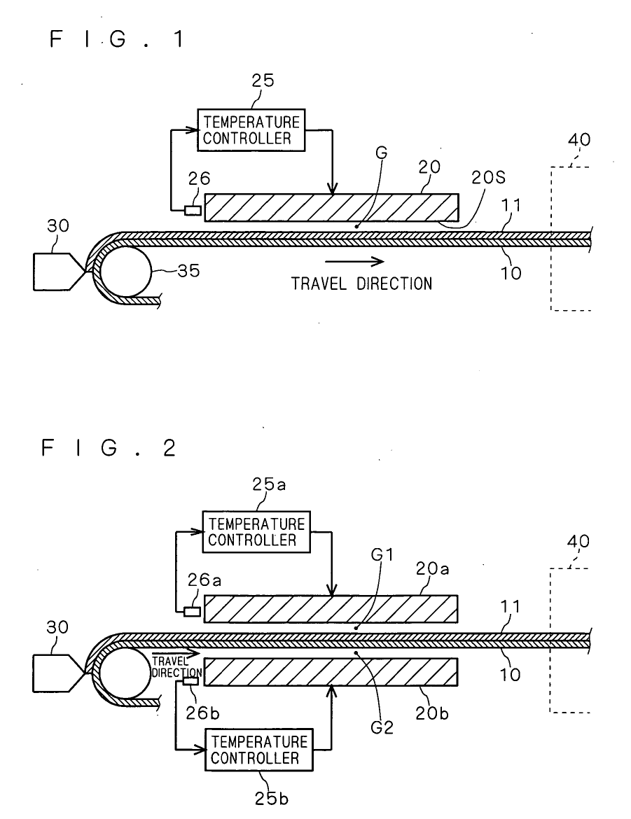

FIG. 1 is a diagram showing a structure in which a plate is provided on the side of a long-length substrate where a coating film is formed. A long-length substrate 10 is a base material for formation of a coating film. It is, for example in the manufacture of a polarizing plate, a long length of flat flexible base material made of a web film or sheet, etc. and travels at about a constant speed in a rightward direction in the drawing while being supported by a plurality of rollers 35 or the like. On a travel path of the long-length substrate 10, a coating system 30 such as a dye coater is provided for applying a coating solution to at least one side (the upper surface side in FIG. 1; the same applies to the other drawings) of the long-length substrate 10, and when the long-length substrate 10 passes through the coating system 30, a coating solution is uniformly applied to the upper surface of the long-length substrate 10 to form a coating film 11. The coating solution is for forming, for example, a protection sheet or optically functional layers of a polarizing plate (concrete examples will be described later).

Immediately following the coating system 30 on the travel path of the long-length substrate 10 (i.e., on the downstream in the manufacturing process), a plate 20 almost parallel to the major surface (coated surface) of the long-length substrate 10 is provided, facing the coating film 11 coated on the long-length substrate 10. There is a certain air gap G between the plate 20 and the coating film 11. A surface 20s of the plate 20 which faces the coating film 11 is finished as smooth as possible. The plate 20 has a plate width that entirely covers the coating film 11 with respect to a width direction of the long-length substrate 10 (a direction perpendicular to the plane of the drawing) and is located along the travel path of the long-length substrate 10. Since the principal purpose of the plate 20 is to prevent the coating film 11, which has been formed on the long-length substrate 10 but has not yet been dried, from being affected by wind or the like from the ambient environment along the travel path, the air gap G between the plate 20 and the coating film 11 should preferably be 10 mm or less. As a result, the air gap between the plate 20 and the coating film 11 is almost filled with vapors of a solvent, and the evaporation rate of the solvent can be reduced to 0.1 g/m²·s or less. Accordingly, the coating film can be dried uniformly and formed to a uniform thickness.

Thus, the plate 20 serves as an evaporation-environment control plate for preventing the coating film 11 from being exposed to outside airflow and for controlling the environment of solvent evaporation from the coating film 11 within the air gap G autonomously and uniformly by the vapor pressure of the solvent itself evaporated from the coating film 11 (not by a forced air blast or the like as in the Japanese Patent Application Laid-open No. 2001-170547).

Further, in order to control the evaporation rate of a solvent, the plate 20 is formed to have a uniform thermal conductivity, and its temperature (especially the temperature of the surface 20s facing the coated surface) is controlled to be not less than the dew point of the solvent by a temperature controller 25 including a heat source. However, also in this case, the temperature is controlled to keep the evaporation rate of the solvent at 0.1 g/m²·s or less. This prevents condensation of vapors of the solvent in the air gap G between the plate 20 and the coating film 11 and allows the evaporation rate to be controlled at any value within the range of not more than 0.1 g/m²·s.

The plate 20 can, for example, be a metal plate or a plate whose underside 20s is covered with a metal layer, and the temperature controller 25 can include, for example, an electrical heater as a heat source. Preferably, a temperature sensor 26 for detecting the temperature of the plate 20 or in the air gap G should be provided for feedback control of the temperature controller 25 using temperature values detected by this temperature sensor 26. This increases the precision of temperature control of the plate 20.

A drying process using the above plate 20 should preferably be performed immediately after the application of a coating solution and until the long-length substrate 10 enters a drying system 40. Such timing effectively prevents a coating solution, which has not yet been dried, from being affected by wind or the like from the ambient environment before entering the drying system 40.

Then, the long-length substrate 10 on which the coating film 11 has been formed and which has passed under the plate 20 enters the conventional drying system 40, where the coating film 11 is completely dried or hardened by heating or ultraviolet irradiation. Here, since the plate 20 provided immediately following the coating system 30 is temperature controlled, the temperature in the air gap G under the plate 20 is higher than the ambient temperature; therefore, the plate 20 has the function of accelerating drying. Thus, the coating film 11 may be dried completely by the function of the plate 20, in which case there is no need to provide the drying system 40.

In the case where the long-length substrate 10 is dried separately in the drying system 40 after passing under the plate 20, the evaporation rate of the solvent may be controlled to be 0 g/m²·s. In this case, the long-length substrate 10 having the coating film 11 formed thereon is led into the drying system 40 without being dried at all in the ambient environment, so that the coating film can be formed to a good and uniform thickness. On the other hand, in the case without providing the drying system 40, it is necessary to completely dry the long-length substrate 10 during the time that the long-length substrate 10 is passing under the plate 20, so that the evaporation rate of the solvent is controlled to be at least higher than 0 g/m²·s. The specific lower limit of the evaporation rate in this case is determined so that complete drying is possible, according to the length of the plate 20 relative to the direction of travel, the travel speed of the long-length substrate 10, and the like.

In order to generate a uniform and stable coating film 11 in this way, the viscosity of a coating solution to be used should preferably be 300 mPa·s or less. More preferably, the viscosity of a coating solution of 50 mPa·s or less enables especially stable drying.

Next, FIG. 2 shows a structure which is different from that of FIG. 1 and in which plates are provided on both sides of a long-length substrate where a coating film is formed and where a coating film is not formed. Immediately following the coating system 30 on the travel path of the long-length substrate 10, a first plate 20a almost parallel to the long-length substrate 10 is provided to face the coating film 11 on the side of the long-length substrate 10 where a coating film is formed, and a second plate 20b almost parallel to the long-length substrate 10 is provided to face the long-length substrate 10 on the side of the long-length substrate 10 where a coating film is not formed. Also in this case, there are certain air gaps G1 and G2 between the first plate 20a and the coating film 11 and between the second plate 20b and the long-length substrate 10, respectively.

By providing the first plate 20a on the side facing the coating film 11, the air gap G1 between the first plate 20a and the coating film 11 is almost filled with vapors of a solvent, and the evaporation rate of the solvent can be reduced to 0.1 g/m²·s or less. Accordingly, the coating film can be dried uniformly and formed to a uniform thickness.

Also by providing the plates 20a and 20b on both sides of the long-length substrate 10 where the coating film is formed and where the coating film is not formed, the influence of wind or the like from the ambient environment can more effectively be prevented.

Further, in order to control the evaporation rate of the solvent, the plates 20a and 20b each are formed to have a uniform thermal conductivity, and the temperatures of the respective plates 20a and 20b (especially the temperatures of the surfaces facing the coated surface or the substrate surface) are individually controlled to be not less than the dew point of the solvent by temperature controllers 25a and 25b, respectively, each including a heat source. Individual control of the plates 20a and 20b enables fine control of the evaporation rate of the solvent, thereby allowing the evaporation rate to be stabilized at 0.1 g/m²·s or less with high precision.

For individual temperature control of the plates 20a and 20b, it is desirable to provide temperature sensors 26a and 26b separately for measuring the temperatures of the plates 20a and 20b, respectively, and the temperatures in the air gaps G1 and G2, respectively, for feedback control of the temperature controllers 25a and 25b, respectively. However, only temperature values detected by either of those sensors (e.g., the temperature sensor 26a on the side facing the coated surface) may be referred to for feedback control of both the two temperature controllers 25a and 25b.

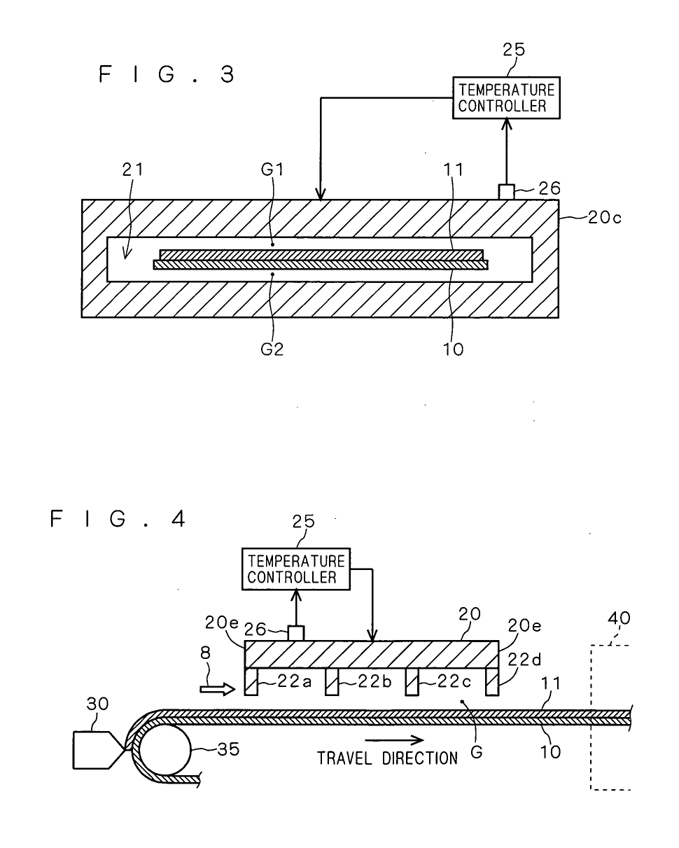

Next, FIG. 3 shows a structure which is different from the one described above and in which a surrounding plate (a flat tunnel structure) 20c is provided to surround a long-length substrate immediately after being coated with a coating solution. FIG. 3 shows a cross-sectional view taken perpendicular to the direction of travel of the long-length substrate 10, and the long-length substrate 10 travels in a direction perpendicular to the plane of the drawing.

In the structure of FIG. 3, the surrounding plate 20c is located immediately following the coating system 30 along the travel path of the long-length substrate 10, and the long-length substrate 10 immediately after the coating film 11 is formed thereon enters into a tunnel of internal space 21 formed by the surrounding plate 20c. That is, the surrounding plate 20c is structured to have plates not only on the sides of the long-length substrate 10 where the coating film is formed and where the coating film is not formed but also on the lateral sides of the substrate. Thus, during the time that the long-length substrate 10 and the coating film 11 travel through the inner space 21 of the surrounding plate 20c, the influence of wind or the like from the ambient environment can considerably be reduced. On the side of the surrounding plate 20c facing the coating film 11, the aforementioned certain air gap G1 is provided between the coating film 11 and the surrounding plate 20c, so that the evaporation rate of a solvent is kept at 0.1 g/m²·s or less.

Further, in order to control the evaporation rate of a solvent, the surrounding plate 20c is formed to have a uniform thermal conductivity, and its temperature (especially the inner surface temperature) is controlled to be not less than the dew point of the solvent by the temperature controller 25 including a heat source. This prevents condensation of vapors of the solvent in the air gap G1 between the surrounding plate 20c and the coating film 11 and in the inner space 21 of the surrounding plate 20c and allows the evaporation rate to be controlled at any value within the range of not more than 0.1 g/m²·s.

Next, FIG. 4 is a diagram showing a structure in which a plurality of flat-plate fins 22a to 22d are provided on the plate 20 in the structure of FIG. 1. As shown in FIG. 4, the fins 22a to 22d are provided perpendicularly on the surface of the plate 20 facing the coating film 11 across the travel path of the long-length substrate 10. In order to keep the lower ends of the fins 22a to 22d out of contact with the coating film 11, a certain gap G is provided between the lower ends of the fins 22a to 22d and the coating film 11.

By, in this way, providing the fins 22a to 22d on the surface of the plate 20 facing the coating film 11, it is possible to reduce the influence of irregular airflow 8 which occurs in consequence of travel of the long-length substrate 10 coated with a coating solution and results in nonuniformity in the evaporation rate of a solvent. More specifically, the airflow 8 occurring in the travel direction is prevented by the fin 22a from entering into the air gap space G between the plate 20 and the coating film 11, so that stable drying becomes possible without the influence of the airflow 8. Although it is conceivable that airflow will also occur within the air gap space G between the plate 20 and the coating film 11, the fins 22b and 22c can prevent a wide range influence of such airflow and allow stable drying. Further, by providing the fins 22a to 22d, the influence of the ambient environment on the air gap space G between the plate 20 and the coating film 11 can effectively be reduced.

The above fins 22a to 22d may be provided at regular intervals in the direction of travel of the long-length substrate 10, or their location intervals in the vicinity of the end portions of the plate 20 may be different from those in the vicinity of the central portion of the plate 20. That is, although, in the vicinity of those end portions (especially in the vicinity of an entrance corresponding to the left side of the drawing), each part of the long-length substrate 10 having the coating film 11 is likely to involve ambient air when entering into the space under the plate 20, the fins which are arranged at relatively short intervals in the vicinity of those end portions can improve the function of preventing the involvement of airflow. Further, as shown in FIG. 4, the fins 20a and 20d on the end portions, out of the plurality of fins 22a to 22d, should preferably be aligned with end surfaces 20e of the plate 20. This prevents the entrance of the airflow 8 at the end portions of the plate 20.

Further, as in the structure of FIG. 1, for control of the evaporation rate of the solvent, the plate 20 is formed to have a uniform thermal conductivity, and its temperature (especially the temperature of the surface facing the coated surface) is controlled to be not less than the dew point of the solvent by the temperature controller 25 including a heat source. This prevents condensation of vapors of the solvent in the air gap space G between the plate 20 and the coating film 11 and between each of the fins 22a to 22d, and allows the evaporation rate to be controlled at any value within the range of not more than 0.1 g/m²·s. Alternatively, the structure may be such that the temperature of the plate 20 is controlled individually for each of partial air gap spaces divided by the respective fins 22a to 22d, in which case the drying condition of the coating solution can be more precisely controlled. In the case of such regional control, if the temperature sensor 26 is provided for each partial space (divided space) for feedback control of temperature in each zone, the function of temperature control will especially be improved. As another alternative, instead of providing fins, the underside of the plate 20 may be corrugated, in which case a plurality of waveform structures each extending in a direction nearly orthogonal to the direction of travel of the long-length substrate 10 should be arranged parallel to each other in the direction of travel of the long-length substrate 10. That is, although the fin arrangement as shown in FIG. 4 is a preferred form, the effect of preventing the involvement of airflow can, in general, be achieved by arranging a plurality of convex structures, each extending in a direction nearly orthogonal to the direction of travel of the long-length substrate 10, in nearly parallel to each other on the underside of the plate 20.

Through the aforementioned coating and drying processes, the above coating film 11 can be formed as, for example, an optically functional layer with optical functions. Then, an optical film or a polarizing plate for use in an image display system can be formed with a lamination of the above optically functional layer(s). That is, the aforementioned drying process is especially useful for formation of optically functional layer(s) to be laminated on an optical film or a polarizing plate.

A polarizing plate has, for example, a structure in which a protection sheet or other optical films are provided on one or both sides of a polarizer made of, for example, a polyvinyl alcohol film containing a dichroic material.

A polarizer can be of various kinds without specific limitation. Examples include those which absorb a dichroic material, such as iodine or dichromatic dye, on a hydrophilic polymer film, such as a polyvinyl alcohol film, a partially formalized polyvinyl alcohol film, or a partially saponified film of ethylene-vinyl acetate copolymer, and which are then uniaxial stretched; and those of polyene compound film, such as dehydrated products of polyvinyl alcohol or dehydrochlorinated products of polyvinyl chloride. Out of these, a polarizer of polyvinyl alcohol film and dichroic material such as iodine is suitable.

In the case of forming a protection sheet on one or both sides of a polarizer as the coating film 11 according to the preferred mode of the present invention, its material should preferably be excellent in transparency, mechanical strength, thermal stability, moisture shielding, isotropy, and the like. Examples include polyester polymers such as polyethylene terephthalate (PET) and polyethylene naphthalate; cellulose polymers such as diacetyl cellulose and triacetyl cellulose; acrylic polymers such as polymethyl methacrylate; styrene polymers such as polystyrene and acrylonitrile-styrene copolymer (AS resin); and polycarbonate polymers. Further examples of polymers for forming a protection sheet include polyolefin polymers such as polyethylene, polypropylene, polyolefin having a cyclane or norbornene structure, and ethylene-propylene copolymer; vinyl chloride polymers; amide polymers such as nylon and aromatic polyamide; imide polymers; sulfone polymers; polyethersulfone polymers; polyetheretherketone polymers; polyphenylene sulfide polymers; vinyl alcohol polymers; vinylidene chloride polymers; vinyl butyral polymers; allylate polymers; polyoxymethylene polymers; epoxy polymers; and a blend of the above polymers.

Or, the protection sheet can be formed as a hardened layer of thermosetting or ultraviolet curing resin such as acrylic, urethane, acrylic-urethane, epoxy, and silicone resins. In this case, the aforementioned drying method should be employed immediately after a coating solution with thermosetting or ultraviolet curing properties is applied to the long-length substrate (polarizer) 10 by the coating system 30 and until the entrance into the drying system 40. By so doing, a uniform and stable hardened layer can be obtained.

Further, the polarizing plate as above described, in practical use, employs various kinds of optically functional layers laminated thereon. Then, the aforementioned drying method can also be used for forming such a lamination of optically functional layers.

Those optically functional layers are not specifically limited. For example, hard coating and antireflection treatment, and surface treatment for the purpose of prevention of sticking or for diffusion or anti-glare purposes may be applied to the surface of a protection sheet opposite to a polarizer, or a liquid-crystal orientation layer for the purpose of viewing-angle compensation or the like may be laminated on that surface. Examples also include polarizing plates which are formed by laminating one or more optically functional layers used for forming an image display system, such as a reflector plate, a semitransparent plate, a retardation plate (including wave plates (A plate) such as a half- or quarter-wave plate), and a viewing-angle compensating layer. Especially preferable are a reflection or semitransparent polarizing plate with a reflector or semitransparent reflector laminated thereon, an elliptical or circular polarizing plate with a retardation plate laminated thereon, a wide-viewing-angle polarizing plate with a viewing-angle compensating layer laminated thereon, and a polarizing plate with a brightness enhancement layer laminated thereon.

The viewing-angle compensating layer is an optically functional layer for widening a viewing angle for relatively clear image, even in the case where the screen of an image display system is viewed from an oblique angle, not from a direction perpendicular to the screen. A wide-viewing-angle polarizing plate with such a viewing-angle compensating layer laminated thereon is formed, for example by supporting an orientation layer, such as a liquid crystal polymer, on a retardation plate, or an orientation film such as a liquid crystal polymer, or a transparent substrate. While an ordinary retardation plate is made of a double-refracting polymer film which is uniaxially stretched in the direction of its plane, a retardation plate for use as a viewing-angle compensating layer is made of, for example, a double-refracting polymer film which is biaxially stretched in the direction of the plane, or a bidirectionally stretched film, such as an inclined orientation film or a double-refracting polymer which is uniaxially stretched in the direction of the plane as well as stretched in the direction of thickness to control the refractive index in the direction of thickness. Examples of the inclined orientation film include those obtained by bonding a heat-shrinkable film to a polymer film and stretching and shrinking the polymer film under the effect of the shrinking force of the heat-shrinkable film; and those obtained by obliquely orienting a liquid crystal polymer. A raw material polymer for a retardation plate is selected as appropriate for the purpose of preventing coloring or the like due to variations in the angle of visibility based on a phase difference brought by a liquid crystal cell, and for the purpose of widening a viewing angle for good visibility.

With a view to achieving a wide viewing angle with good visibility, an optically compensating retardation plate is desirably used, which supports an orientation layer of liquid crystal polymer, especially an optically anisotropic layer formed of an inclined orientation layer of discotic liquid crystal polymer, on a triacetyl-cellulose film. For formation of a viewing-angle compensating layer with this kind of optical compensation function, the aforementioned drying method is applicable. For example, the aforementioned drying method can be applied to the case of applying a coating solution containing a discotic liquid crystalline compound to a long length of triacetyl-cellulose film and then drying a resultant coating film. Thereby, a retardation plate with little unevenness in appearance can be obtained.

A polarizing plate with a brightness enhancement layer laminated thereon is usually provided for use on the back sides of a liquid crystal cell. The brightness enhancement layer has the property of reflecting linearly polarized light with a predetermined polarization axis or circularly polarized light with a predetermined direction and transmitting all the other lights, when receiving natural light from a backlight of an image display system, such as a liquid crystal display, or by reflection from the back side. A polarizing plate with the brightness enhancement layer laminated thereon receives light from a light source such as a backlight to obtain a predetermined polarized state of transmitted light and to reflect light other than that predetermined polarized state of light without transmitting. Light reflected off the film surface of such a brightness enhancement layer is further inverted through a reflecting layer or the like provided on the backside of the brightness enhancement layer to reenter the brightness enhancement layer. Then, part or all of the reentering light is transmitted as a predetermined polarized state of light to increase the amount of light that can pass through the brightness enhancement layer, and polarized light which is hardly absorbed by a polarizer is supplied to increase the amount of light that can be used for image display, whereby the brightness is enhanced. That is, in the case where light from the backlight or the like is incident from the backside of liquid crystal cells through a polarizer without using a brightness enhancement layer (brightness enhancement film), light with such polarization directions that do not match the polarization axis of the polarizer will mostly be absorbed by the polarizer and will not pass through the polarizer. More specifically, although depending on the properties of a polarizer to be used, approximately 50% of light is absorbed by a polarizer, which results in a corresponding reduction in the amount of light that can be used for image display, thereby darkening images. In the brightness enhancement layer, light with such polarization directions that can be absorbed by a polarizer is once reflected off the brightness enhancement layer without entering a polarizer, and then inverted through a reflecting layer or the like provided on the backside of the brightness enhancement layer to reenter the brightness enhancement layer. This is repeated and only polarized light which is enabled to have a polarization direction that can pass through a polarizer, after being reflected and inverted between the brightness enhancement layer and the reflecting layer, is transmitted and supplied to the polarizer. This allows effective use of light such as backlight for image display, thereby brightening images.

Further, a diffusion plate may be provided between the brightness enhancement layer and the reflecting layer. A polarized state of light reflected off the brightness enhancement layer is directed to the reflecting layer or the like, and the diffusion plate provided uniformly diffuses light passing therethrough and simultaneously depolarizes the light to a nonpolarized state. That is, the light returns to the original state of natural light. This nonpolarized state of light, i.e., the natural light, is directed to and reflected through the reflecting layer or the like, passes again through the diffusion plate, and reenters the brightness enhancement layer, which is repeated. By providing the diffusion plate for returning light to the original state of natural light, it is possible to keep the brightness of the display screen and simultaneously reduce unevenness in the brightness of the display screen and thereby to provide a uniform and clear screen. By providing the diffusion plate for returning light to the original state of natural light, it is also possible to adequately increase the number of times that the reflection of an initial incident light is repeated, which together with the diffusion function of the diffusion plate, allows the provision of a uniform and clear display screen.

For the brightness enhancement layer showing the aforementioned optical functions, appropriate ones can be selected, such as an orientation film of cholesteric liquid crystal polymer or those formed by supporting on a film base material a liquid-crystal orientation layer included in that orientation film; that is, such as those having the property of reflecting either clockwise or counterclockwise circularly polarized light and transmitting the other lights. The aforementioned drying method is also applicable to formation of this kind of brightness enhancement layer. For example, the aforementioned drying method can be applied to the case of applying a coating solution for forming a liquid-crystal orientation layer to a long length of film base material and drying a resultant coating film. Thereby, a brightness enhancement layer with little unevenness in appearance can be formed.

The brightness enhancement layer may also be a multilayer thin film of dielectric or a multilayer laminated material of thin films with different refractive index anisotropy; that is, it may be the one having the property of transmitting linearly polarized light with a predetermined polarization axis and transmitting the other lights. This kind of brightness enhancement layer transmits its transmitting light as-is to a polarizing plate with an aligned polarization axis, thereby reducing loss by absorption into a polarizing plate and allowing efficient transmission. Thus, this kind of brightness enhancement layer may be laminated on an optically functional layer formed by the aforementioned drying method, which thereby forms a polarizing plate with a multilayer structure.

On the other hand, a type of brightness enhancement layer that transmits circularly polarized light, such as a cholesteric liquid crystal layer, can also transmit light as-is to a polarizer; however, with a view to reducing the loss by absorption, it is desirable to transform circularly polarized light into linearly polarized light through a retardation plate and then transmit the light to a polarizing plate. For the transformation of circularly polarized light into linearly polarized light, a quarter-wave plate can be used as a retardation plate.

A retardation plate functioning as a quarter-wave plate in a wide wavelength range such as a visible light range can be obtained, for example by superimposing a retardation layer functioning as a quarter-wave plate for monochromatic light with a wavelength of 550 nm and another retardation layer showing other retardation properties, such as a retardation layer functioning as a half-wave plate. Thus, a retardation plate to be provided between the polarizing plate and the brightness enhancement layer may be formed of one or more retardation layers. Such retardation layers can also be formed by applying a coating solution to form a coating film and then drying the coating film, thereby to have little unevenness in appearance.

As so far described, in forming various kinds of optically functional layers, uniform optically functional layers can be formed by applying a coating solution to a long-length substrate (such as film) as a base material to form a coating film and then drying the coating film by the aforementioned drying method. Laminating such optically functional layer(s) on an optical film can produce a uniform and high-quality optical film. Further, laminating such an optical film on a polarizing plate can produce a uniform and high-quality polarizing plate.

As an alternative, a polarizing plate may be formed of a polarizing plate and two or more optically functional layers laminated thereon. Thus, it may be, for example, a reflection or semitransparent elliptical polarizing plate that is a combination of a reflection or semitransparent polarizing plate and a retardation plate. Further, the optical film or the polarizing plate should have at least one optically functional layer formed thereon by the aforementioned drying method. Thus, in an optical film or a polarizing plate with a multilayer structure, at least one layer should be formed by the aforementioned drying method, and the other layer(s) may be formed by other conventional technique(s).

Further, in the case of laminating such an optically functional layer as above described on a protection sheet, the timing of the lamination may be either before or after the protection sheet is laminated to a polarizer. In the case of laminating an optically functional layer to a protection sheet by application of a coating solution, the protection sheet alone or a laminate of a polarizer and the protection sheet are taken as the long-length substrate 10, and the aforementioned drying method can be applied immediately after a coating solution with optical functions is applied to the long-length substrate 10 in the coating system 30 and until a resultant coating film enters the drying system 40. That drying method allows stable drying, thereby producing a uniform optically functional layer.

Further, in the case of laminating an optical film including an optically functional layer as above described to a polarizing plate, a method of lamination may be such that the optical film and the polarizing plate are generated individually and then laminated together in the manufacturing process of an image display system such as a liquid-crystal display. However, if the optical film is laminated beforehand on the polarizing plate, there are the advantages of stable quality, superiority in assembly operation and the like, and efficiency in the manufacturing process of an image display system.

The polarizing plate obtained as above described can preferably be used for formation of a liquid crystal display. For example, it can be used for a reflection or semitransparent, or reflection-transparent liquid crystal display in which a polarizing plate is disposed on one or both sides of a liquid crystal cell. A liquid-crystal cell substrate may be either a plastic or glass substrate. Further, liquid crystal cells forming a liquid crystal display are arbitrary and may be of any appropriate type, such as an active matrix drive type represented by thin-film transistor type, and a simple matrix drive type represented by twist nematic and super-twist nematic types. Using, for liquid crystal displays, a polarizing plate with a laminated structure of optically functional layer(s) formed by the aforementioned drying method, the liquid crystal display can achieve uniform and high-quality image display.

Further, the polarizing plate produced as above described can preferably be used not only for liquid crystal displays but also for image display systems such as organic EL displays and plasma displays.

By using, for image display systems, a polarizing plate having optically functional layer(s) laminated thereon by the aforementioned drying method, it is possible to obtain an image display system having an even appearance, with stability. Also, the image display system achieves uniform and high-quality image display.

Hereinbelow, examples and comparative examples are shown to explain the present invention in further details. However, the present invention is not limited by those examples and comparative examples.

### EXAMPLE 1

A coating solution with a viscosity of 6 mP·s (measured by a Thermo Haake Rheometer, RS-1), in which a ultraviolet curing liquid-crystal monomer is diluted with an organic solvent (cyclopentanone) to a solids content of 30%, is applied by a die coater on a PET film (with a thickness of 75 μm) to give a thickness of 4.0 μm after drying. This resultant coating film is, as shown in FIG. 1, passed through a zone where the plate 20 is provided with a predetermined air gap G between itself and the coating film; dried by hot air at 70° C. in the coating system 40; and cured by ultraviolet radiation (with an integrated quantity of light of 300 mJ/cm²), thereby to obtain a sheet with an optically functional layer. At this time, the evaporation rate of the coating solution in the zone where the plate 20 is provided is 0.03 g/m²·s, which measured based on the gas concentration distribution of generated vapors and the air flow (wind velocity).

Now in batch drying, the fact that there is a correlation between the evaporation rate and the gas concentration distribution of generated vapors has been confirmed by the inventors and others. In batch processing, a relationship (calibration curve) among the gas concentration, the wind velocity, and the drying rate is previously calculated by putting a coating solution on an electronic scale and measuring its weight change with time while monitoring the gas concentration and the wind velocity. In this example, the evaporation rate is calculated using this relationship. More specifically, a hole is made in a central portion of the plate 20 with respect to both the direction of flow and the direction of width of the base material, and sensors respectively of a gas concentration measuring device (a portable VOC monitor of Yokogawa Electric Corporation) and a wind velocity measuring device (ANEMOMASTER, Kanomax Japan, INC.) are placed in the hole to measure the gas concentration and the wind velocity. Then, using the relationship previously obtained by the aforementioned method, the above evaporation of 0.03 g/m²·s is obtained.

In this example, the wind direction is the same direction (forward direction) as the direction of travel of the base material, and the wind velocity measured is 0.1 m/s.

### COMPARATIVE EXAMPLE 1

A coating film is formed under the same conditions as in the case of Example 1, except that the plate 20 is removed. At this time, the evaporation rate of a coating solution in a portion where the plate 20 is removed is 0.12 g/m²·s, when measured in the same manner as above described.

In this comparative example, the respective sensors of the gas concentration measuring device and the wind velocity measuring device are located in the same positions as those in the case of Example 1 and 5mm away from the surface of the coating film. The wind velocity checked at this time is the same as in the case of Example 1.

Evaluation 1.

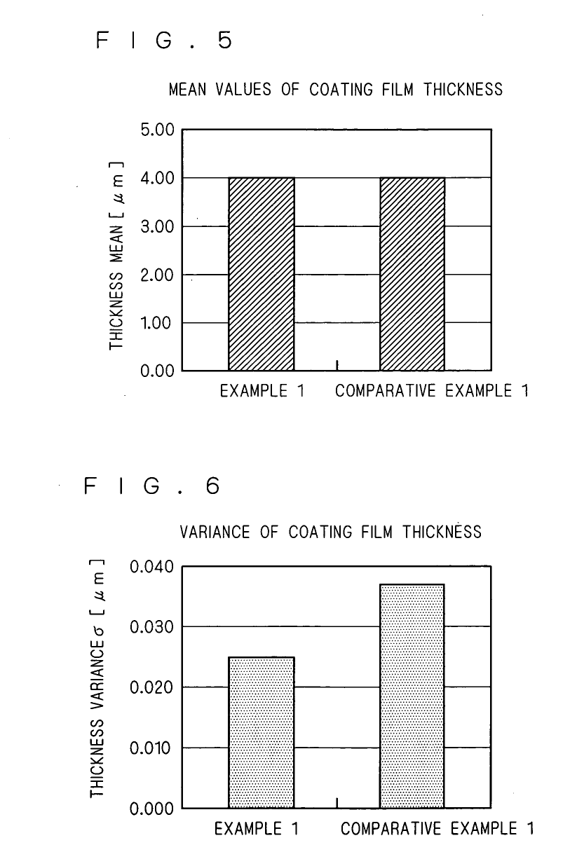

FIG. 5 shows the mean values of the coating film thickness in Example 1 and Comparative Example 1, and FIG. 6 shows the variance of the coating film thickness. As shown in FIG. 5, there is no difference in the mean values of the coating film between Example 1 and Comparative Example 1; however, as shown in FIG. 6, the variance of the coating film in Example 1 is smaller than that in Comparative Example 1, which shows that an optically functional layer with smaller variations in thickness can be formed. Thus, if drying is done immediately after the application of a coating solution with the evaporation of the coating solution kept at 0.1 g/m²·s or less, an optically functional layer with smaller variations in thickness will be formed as compared with the case of employing greater evaporation rates.

Further, when the thickness variance is 0.03 μm or less, uneven film appearance becomes unobtrusive; therefore, a good optical film can be obtained through drying with the evaporation rate of 0.1 g/m²·s or less as in the case of Example 1.

### EXAMPLE 2

A coating solution (with a viscosity of 250 mP·s), in which a thermosetting resin is diluted with an organic solvent (MIBK: methyl isobutyl ketone) to a solids content of 10%, is applied by a die coater on a TAC film (with a thickness of 85 μm) to give a thickness of 3.0 μm after drying. This resultant coating film is, as shown in FIG. 1, passed through a zone where the plate 20 is provided with a predetermined air space G between itself and the coating film, and is dried by hot air at 100° C. in the coating system 40, thereby to obtain a sheet with an optically functional layer. At this time, the evaporation rate of the coating solution in the zone where the plate 20 is provided is 0.06 μ/m²·s, which measured, as in Example 1, based on the gas concentration distribution of generated vapors and the air flow (wind velocity).

Also in this example, the same devices as those in Example 1 are used for measuring the viscosity of the coating solution, and the wind velocity checked at this time is the same as that in Example 1.

### COMPARATIVE EXAMPLE 2

A coating film is formed under the same conditions as in the case of Example 2, except that the plate 20 is removed. At this time, the evaporation rate of a coating solution in a portion where the plate 20 is removed is 0.15 g/m²·s, when measured in the same manner as above described.

Also in this comparative example, the respective sensors of the gas concentration measuring device and the wind velocity measuring device are located in the same positions as those in the case of Example 2. Then, the wind velocity checked at this time is 0.1 m/s.

Evaluation 2

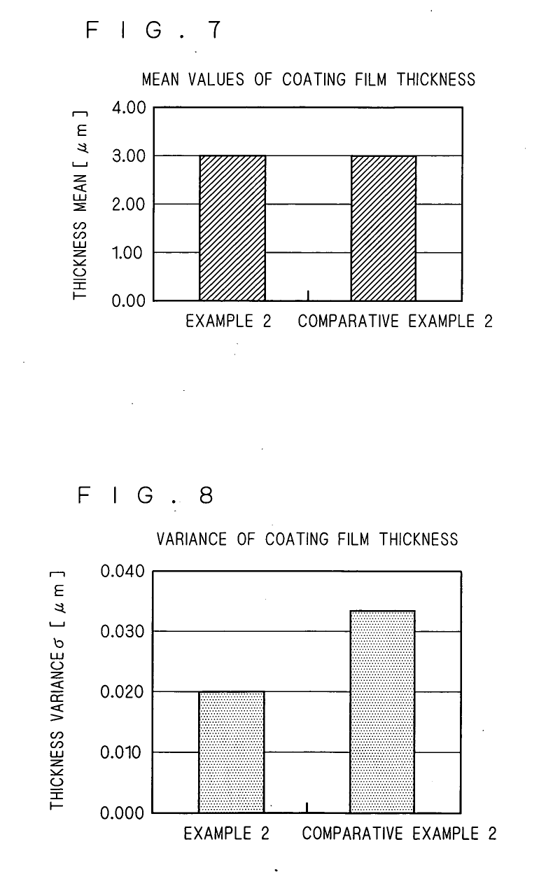

FIG. 7 shows the mean values of the coating film thickness in Example 2 and Comparative Example 2, and FIG. 8 shows the variance of the coating film thickness. As shown in FIG. 7, there is no difference in the mean values of the coating film between Example 2 and Comparative Example 2; however, as shown in FIG. 8, the variance of the coating film is smaller in Example 2 than in Comparative Example 2, which shows that an optically functional layer with smaller variations in thickness can be formed. Thus, if drying is done immediately after the application of a coating solution with the evaporation of the coating solution kept at 0.1 g/m²·s or less, an optically functional layer with small variations in thickness will be formed as compared with the case of employing greater evaporation rates. Further, the thickness variance in Example 2 is also 0.03 μm or less, which allows the production of a good optical film whose uneven appearance is unobtrusive.

While the invention has been shown and described in detail, the foregoing description is in all aspects illustrative and not restrictive. It is therefore understood that numerous modifications and variations can be devised without departing from the scope of the invention.

1. A method of drying a coating film formed by application of a coating solution to a long-length substrate which is traveling,
drying being done immediately after the application of said coating solution to said long-length substrate, with an evaporation rate of a solvent kept at 0.1 g/m²·s or less.

2. The method of drying a coating film as set forth in claim 1, characterized in that said drying is done until said long-length substrate coated with said coating solution enters a drying system.

3. The method of drying a coating film as set forth in claim 1, characterized in that a plate parallel to said long-length substrate immediately after being coated with said coating solution is provided with an air gap between said plate and said coating film, and said drying is done during travel of said coating film through said gap.

4. The method of drying a coating film as set forth in claim 3, characterized in that a temperature of said plate is controlled to be not less than a dew point of vapors of said coating solution.

5. The method of drying a coating film as set forth in claim 3, characterized in that a fin is provided on a surface of said plate on a side facing said long-length substrate.

6. The method of drying a coating film as set forth in claim 1, characterized in that said coating film is formed as an optically functional layer with an optical function.

7. An optical film having a laminated structure comprising said optically functional layer formed by the method of drying a coating film as set forth in claim 6.

8. A polarizing plate having the optical film as set forth in claim 7.

9. An image display system comprising the polarizing plate as set forth in claim 8.

10. A method of drying a coating film formed by application of a coating solution to a long-length substrate which is traveling, characterized in that
a plate having a plate width of not less than a width of said long-length
substrate is provided along a travel path of said long-length substrate on a downstream side of a coating system for said coating solution, and
said long-length substrate immediately after a coating film is formed thereon by said coating system travels along said travel path, with said coating film facing a plate surface of said plate with a predetermined gap, whereby at least pat of said coating film is dried while passing through said gap.

11. The method of drying a coating film as set forth in claim 10, characterized in that
said plate is provided as a first plate, and a second plate which is opposed with a predetermined space to a surface of said long-length substrate on a side opposite to the side where said coating film is formed, is provided almost parallel to said first plate, and
a long-length substrate immediately after said coating film is formed thereon travels through an air gap between said first and second plates.

12. The method of drying a coating film as set forth in claim 10, characterized in that a plurality of convex structures, each extending in a direction nearly orthogonal to a direction of travel of said long-length substrate, are arranged approximately parallel to an underside of said plate along said direction of travel.

13. The method of drying a coating film as set forth in claim 10, characterized in that said plate is provided as one side of a flat tunnel structure which surrounds a travel path of said long-length substrate.

14. The method of drying a coating film as set forth in claim 10, characterized in that a temperature of said plate is controlled to be not less than a dew point of vapors of said coating solution.
